(19) United States
(12) Patent Application Publication
(10) Pub. No.: US 2026/0230770 A1
(43) Pub. Date: Aug. 6, 2026

(54) INFORMATION GENERATION METHOD ENABLING OBJECTIVE ENHANCEMENT OF PERCEIVED TIMBRE BASED ON HUMAN THREE-DIMENSIONAL BODY SHAPE, AND SOUND DATA PROCESSING DEVICE ALLOWING INTUITIVE AND EASY CHANGE OF PERCEIVED SOUND IMPRESSION

(71) Applicant: FINAL INC., Kanagawa (JP)

(72) Inventor: Kimio HAMASAKI, Kanagawa (JP)

(21) Appl. No.: 19/154,505

(22) PCT Filed: Apr. 28, 2023
(86) PCT No.: PCT/JP2023/016991

§ 371 Date: Aug. 7, 2025

(51) Int. Cl. H04S 7/00

(52) U.S. Cl. CPC H04S 7/303

(57) ABSTRACT

A system acquires head-related transfer functions (HRTFs) obtained by emitting sound toward the head of an individual from multiple sound emission directions in an anechoic chamber, averages the plurality of HRTFs, and calculates a target response curve (TRC) for the individual, which is referred to as TPTRC, and which clarifies information related to sound timbre. The system generates TPTRC(W) by multiplying the TPTRC by each of different multipliers W, presents sounds conforming to the respective TPTRC(W) to individual, to prompt individual to select from among the sounds a preferred sound, storing the TPTRC(W) selected by individual as TPTRCadj. The system generates a generic TPTRCadj by averaging TPTRCadj stored for each of a plurality of different individuals. A sound data processing device superimposes the generic TPTRCadj on input sound data and outputs the processed sound data to a sound-emitting device such as earphones.

### CROSS REFERENCE TO RELATED APPLICATIONS

This application is a 371 U.S. National Phase of International Application No. PCT/JP2023/016991, filed on Apr. 28, 2023. The entire disclosure of the above application is incorporated herein by reference.

### TECHNICAL FIELD

The present invention relates to acoustic technology, and more specifically, to technology for enhancement of perceived timbre.

### BACKGROUND ART

In sound-emitting devices such as earphones, headphones, and speakers, an amplitude frequency characteristic is set for commercial implementation to a target frequency response. Hereinafter, a target frequency response is referred to as “target response” (TR), and an amplitude frequency characteristic is referred to as a “target response curve” (TRC).

A TRC of sound-emitting devices differs according to product and/or manufacturer. For example, well-known TRCs include the Harman TRC proposed by Harman International (USA), the free field TRC derived based on sound wave propagation to the human body in a free field, and the diffuse field TRC derived based on sound wave propagation in a diffuse field.

JP2001-224100A (Patent Document 1) discloses a technology that uses TRCs. In the invention described in Patent Document 1, audio signals input to a speaker are corrected by a graphic equalizer such that sound with an amplitude frequency characteristic conforming to a TRC selected by a listener from multiple TRCs is emitted.

With respect to a sound quality of sound-emitting devices, although manufacturers set desirable TRCs for each product, listener satisfaction with regard to sound quality, especially timbre, is known to vary significantly.

To solve the above problem, listeners commonly adjust an amplitude frequency characteristic using a parametric or graphic equalizer. However, such adjustments, which change timbre subjectively, give rise to problems such as varying levels of satisfaction with regard to timbre depending on changes in music.

In view of the foregoing, the present invention provides means for objectively generating sound with a timbre that yields a high level of satisfaction for listeners.

### SUMMARY

The present invention provides a method for generating information to enhance timbre using characteristics of an individual, comprising: identifying, for each of multiple directions from which sound is emitted toward a head of the individual, a transfer function or information equivalent to the transfer function representing sound reaching an ear of the individual; and calculating an averaged transfer function, or information equivalent to the averaged transfer function, by averaging the transfer functions or the information equivalent to the transfer function identified for each of the multiple directions.

### Advantages of the Invention

According to the present invention, information is obtained that objectively represents amplitude frequency characteristics of timbre that yield a high level of satisfaction for an individual listener.

### BRIEF DESCRIPTION OF THE DRAWINGS

FIGS. 1A-1C are diagrams explaining the sound emission directions D in the method according to the exemplary embodiment.

FIG. 2 is a flowchart of the method for generating TRC-I according to the exemplary embodiment.

FIG. 3 is a flowchart of the method for generating TRC-I according to the exemplary embodiment.

FIG. 4 is a flowchart of the method for generating TRC-I according to the exemplary embodiment.

FIG. 5 is a diagram illustrating the configuration of a sound data processing system according to the exemplary embodiment.

FIG. 6 is a diagram illustrating the configuration of a sound-emitting device according to the exemplary embodiment.

### DETAILED DESCRIPTION

### First Embodiment

Hereinafter, an exemplary embodiment of a method for generating information to enhance timbre using individual characteristics according to the present invention will be described as a first embodiment. According to the method described below, a TRC (hereinafter referred to as “TRC-I”) for generating sound that provides a high level of satisfaction with regard to timbre when heard by a listener can be obtained.

Generation of TRC-I is mainly performed by a data processing device. The data processing device used for generating TRC-I is, for example, a general-purpose computer. The general-purpose computer includes a memory for storing various data, a processor for performing various data processing in accordance with programs stored in the memory, and an interface for input/output or communication of data with external devices. By the processor performing data processing according to the program related to this embodiment stored non-transitorily in the memory, a system (hereinafter referred to as “system S”) that performs the following operations (including data processing) is realized.

### First Example

Next, a first example of the first embodiment is described. In this example, the generation of TRC-I uses head-related transfer functions (HRTFs) for the left and right ears corresponding to multiple sound emission directions toward the head of an individual P. The multiple directions from which sounds are emitted for specifying HRTFs are collectively referred to as sound emission directions D.

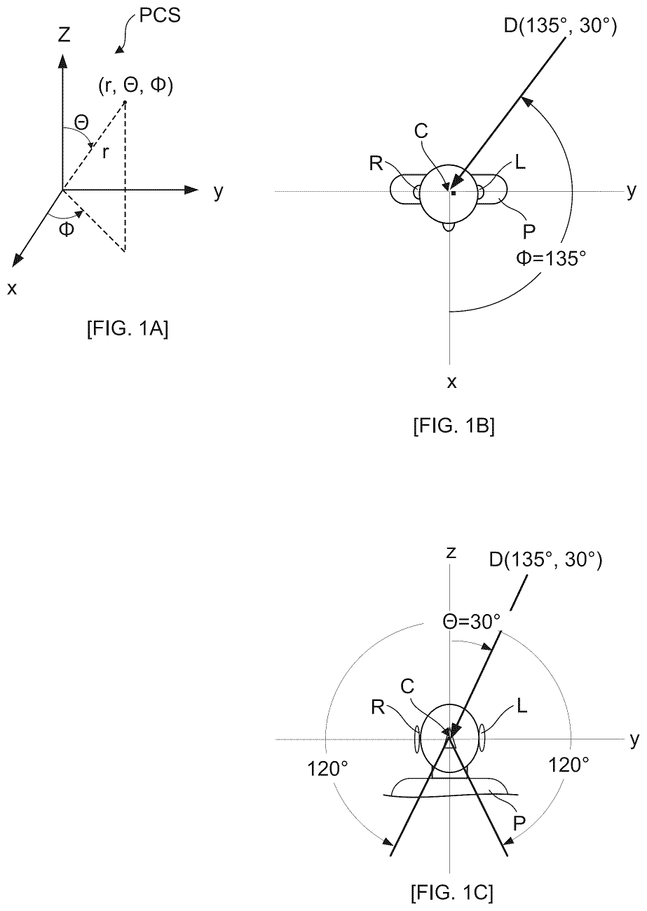

FIGS. 1A to 1C illustrate the sound emission directions D in this example. FIG. 1A shows a polar coordinate system PCS used to define the sound emission directions D. FIG. 1B shows individual P viewed from above in the negative z-direction of the polar coordinate system PCS. FIG. 1C shows individual P viewed from the front in the negative x-direction of the PCS. The head center point C, which is the midpoint of the line segment connecting the left ear L and right ear R of individual P, is set as the origin of the PCS. Individual P is positioned in the PCS such that the front direction of individual P corresponds to the positive x-direction of the PCS, and the left direction corresponds to the positive y-direction of the PCS. Each sound emission direction D points toward the origin (head center point C). Each sound emission direction D is identified by a combination of an azimuth angle Φ (FIG. 1B), which is the angle viewed from above with the positive x-direction as the reference (0 degrees) measured counterclockwise, and an elevation angle Θ (FIG. 1C), which is the angle with the positive z-direction as the reference (0 degrees). The sound emission direction D with azimuth Φ and elevation Θ is hereinafter expressed as sound emission direction D(Φ, Θ). For example, the sound emission direction D(135°, 30°) shown in FIGS. 1A to 1C indicates a direction with an azimuth angle of 135° and an elevation angle of 30°, i.e., the direction from the upper left rear of individual P toward the head center point C.

In this example, the azimuth angle of the sound emission direction D ranges from 0° to 360°, and the elevation angle ranges from 0° to 120°; however, the present invention is not limited thereto.

In this example, the azimuth angle increment and the elevation angle increment of the sound emission direction D are each assumed to be 5 degrees; however, the present invention is not limited thereto. When each increment is 5 degrees, the total number of sound emission directions D is calculated as (360÷5)×(120÷5)+1=1729.

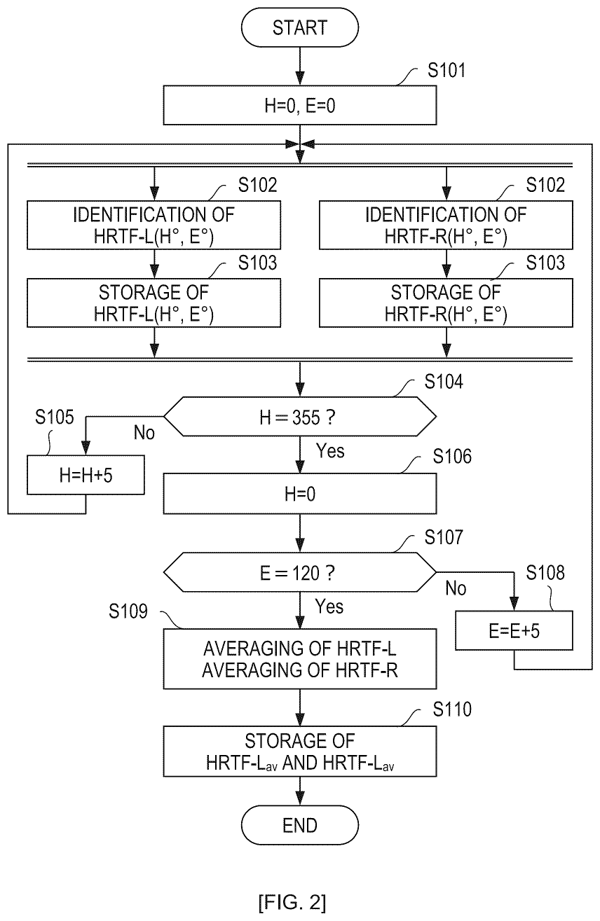

FIG. 2 is a flowchart illustrating a method for generating TRC-I according to this example.

System S initializes both a counter H for the azimuth angle and a counter E for the elevation angle to 0 (Step S101).

Next, system S identifies the head-related transfer function (HRTF) for the left ear and right ear of individual P in an anechoic chamber when a sound is emitted toward the head center point C from the sound emission direction D (azimuth angle H degrees and elevation angle E degrees), and the sound reaches an ear (Step S102). Hereinafter, the HRTF related to the left ear is denoted as “HRTF-L,” and that related to the right ear as “HRTF-R.” Also, the HRTF corresponding to the sound emission direction D (H degrees, E degrees) is denoted as “HRTF-L (H degrees, E degrees)” or “HRTF-R (H degrees, E degrees).”

Any known method may be adopted for identifying the HRTF. Examples include, but are not limited to, the following:
(1) Emitting a test sound from an actual speaker in an anechoic chamber and measuring the HRTF at the ear canal entrance using a miniature microphone, probe microphone, or the like.
(2) Using a 3D shape model obtained by scanning or photographing the head and outer ear, and calculating the HRTF by simulation based on a wave equation.

System S stores the identified HRTF-L (H degrees, E degrees) and HRTF-R(H degrees, E degrees) (Step S103).

Then, system S determines whether the counter H equals 355 (Step S104). If no (Step S104; No), system S adds 5 to counter H (Step S105), and repeats the process starting from Step S102.

If counter H equals 355 (Step S104; Yes), system S resets counter H to 0 (Step S106). Next, system S determines whether counter E equals 120 (Step S107). If no (Step S107; No), system S adds 5 to counter E (Step S108), and repeats the process starting from Step S102.

If counter E equals 120 (Step S107; Yes), system S calculates the averaged HRTF-L (hereinafter referred to as “HRTF-Lav”) as the average of the 1729 HRTF-Ls stored at Step S103, and calculates the averaged HRTF-R (“HRTF-Rav”) as the average of the 1729 HRTF-Rs (Step S109).

In this application, the average value of the HRTF is obtained by averaging the amplitude frequency characteristics represented by the HRTF function with respect to amplitude. The term “HRTF” used herein denotes either the function or the amplitude frequency characteristic represented by the function. That is, the function and the amplitude frequency characteristic obtained by converting the function into the frequency domain are equivalent information and are not distinguished herein. Moreover, the term “HRTF” may also denote the impulse response or step response converted from the HRTF; such information is also equivalent to the HRTF, and is not distinguished herein.

The averaging performed at Step S109 is not limited to an arithmetic mean (simple average), but may be a generalized average such that, assuming all values in the target set are equal to a certain value, the reference value yields the same result as the actual values. That is, any of an arithmetic mean, weighted mean, geometric mean, or the like may be adopted.

Furthermore, the frequency band subjected to averaging at Step S109 may be changed depending on use. Averaging may be performed over the entire audible frequency range, or, for example, over only a frequency band from 800 Hz to 12 kHz. At a boundary between averaged and non-averaged frequency bands, multiplication by a window function or the like is applied for amplitude smoothing.

Because HRTF-Lav and HRTF-Rav are averages of HRTFs from various directions, information necessary for sound localization is canceled, thereby clarifying information that affects timbre recognition. As a result, sound obtained by superimposing HRTF-Lav and HRTF-Rav on original sound yields a high level of satisfaction with regard to timbre for individual P.

For example, the simple average HRTF-Lav and HRTF-Rav, calculated without weighting sound emission directions D, provide sound with nearly all localization information canceled. On the other hand, when weighted averages using different weights for each sound emission direction D are calculated as HRTF-Lav and HRTF-Rav, the listener senses sound localization such that sound is emitted from directions that are assigned larger weights.

Therefore, for example, sound obtained by superimposing HRTF-Lav and HRTF-Rav calculated by weighted averaging with weights assigned as follows provides a high level of satisfaction with regard to timbre for individual P, as well as a sense of sound coming from the front.
HRTFs with azimuth angles Φ in the ranges 0° to 45° and 315° to 360° are assigned weight “1.”
HRTFs with azimuth angles Φ of 90° and 270° are assigned weight “−2.”
HRTFs with azimuth angles Φ of 135° and 225° are assigned weight “−4.”
HRTFs with azimuth angle Φ of 180° are assigned weight “−6.”

For HRTFs with azimuth angles Φ within the range 45° to 315° excluding the above angles, weights are assigned by interpolating (e.g., using linear interpolation) the weights at 45°, 90°, 135°, 180°, 225°, 270°, and 315°.

In the above example weights vary according to azimuth angle; alternatively, weights may vary according to elevation angle, or according to combinations of azimuth and elevation angles.

HRTF-Lav and HRTF-Rav calculated as described above reflect the 3D body shape of individual P, and can be used as new TRCs that clarify information affecting timbre recognition. Accordingly, in the following description, HRTF-Lav and HRTF-Rav are referred to as TPTRC (Timbre Personalized Target Response Curve).

In the following description, unless specifically stated otherwise, data processing relating to the left ear and to the right ear is not distinguished.

System S stores the TPTRC calculated at Step S109 (Step S110). The TPTRC stored in this manner is the TRC-I in this example.

### Second Example

Next, a second example of the first embodiment will be described.

In the method of this example, multiple amplitude-scaled TPTRCs are prepared by multiplying the amplitude of the TPTRC stored at Step S110 in the first example by different multipliers (hereinafter “multiplier W”), denoted as TPTRC(W). Sounds obtained by superimposing these TPTRC(W)s scaled by different multipliers W on evaluation sounds (e.g., existing music) are presented to individual P, who selects from among these sounds a preferred sound, and the TPTRC(W) providing the highest level of satisfaction for individual P is specified as TRC-I.

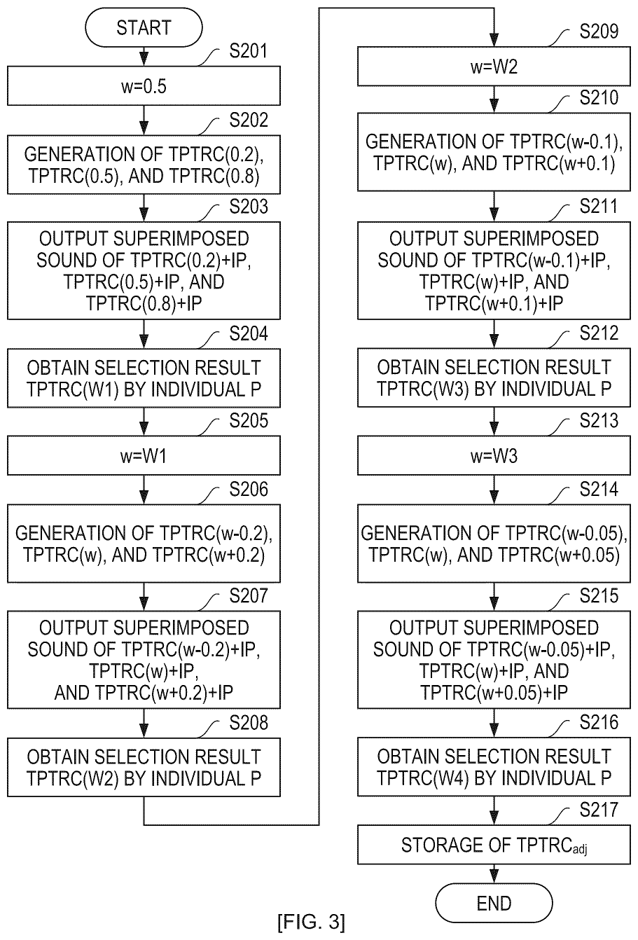

FIG. 3 is a flowchart illustrating the method for generating TRC-I according to this example.

First, system S assigns an initial value of 0.5 to a variable w that holds the median candidate of multiplier W (Step S201).

Next, system S multiplies the amplitude of TPTRC by (w−0.3), w,_and (w+0.3) respectively, generating three amplitude-scaled TPTRCs, namely TPTRC(0.2), TPTRC(0.5), and TPTRC(0.8) (Step S202).

The frequency band to which the multiplier multiplication on amplitude is applied in at Step S202 (and at subsequent Steps S206, S210, and S214) may be changed depending on use. That is, multiplication by the multiplier may be performed over the entire audible frequency range, or only over a specific frequency band such as 900 Hz to 11 kHz. At boundaries between bands subject to multiplication and bands not subject to multiplication, multiplication by a window function or the like is performed for amplitude smoothing.

Then, system S sequentially outputs sounds obtained by superimposing on evaluation sounds each of the TPTRC(0.2), TPTRC(0.5), and TPTRC(0.8) generated at Step S202 and an inverse characteristic IP, which is the inverse characteristic of the inherent TRC of a sound-emitting device such as earphones connected to system S, to the sound-emitting device (Step S203). If the sound-emitting device has a flat TRC, superimposition of inverse characteristic IP is unnecessary (the same applies to Steps S207, S211, and S215 described later).

Individual P listens to the sounds emitted from the sound-emitting device at Step S203, and selects one that provides a highest level of satisfaction, and inputs the selection result to system S. System S acquires the selection result input by individual P (Step S204).

System S assigns the multiplier W used to generate the TPTRC(W) corresponding to the selection result acquired at Step S204 (hereinafter referred to as multiplier W1) to variable w (Step S205). For example, if the selection result specifies the sound superimposed with TPTRC(0.2), system S assigns 0.2 to variable w at Step S205.

Next, system S multiplies the amplitude of TPTRC by (w−0.2), w, and (w+0.2), respectively, generating three amplitude-scaled TPTRCs (Step S206). For instance, if variable w is set to 0.2 at Step S205, system S generates TPTRC(0.0), TPTRC(0.2), and TPTRC(0.4) at Step S206.

System S then sequentially outputs sounds obtained by superimposing on evaluation sounds each of the three TPTRC(W)s generated at Step S206 and the inverse characteristic IP to the sound-emitting device connected to system S (Step S207).

Individual P listens to the sounds emitted at Step S207, selects one that provides a highest level of satisfaction, and inputs the selection result to system S. System S acquires the selection result input by individual P (Step S208).

System S assigns the multiplier W used to generate the TPTRC(W) corresponding to the selection result acquired in Step S208 (hereinafter multiplier W2) to variable w (Step S209). For example, if the selection result specifies the sound superimposed with TPTRC(0.4), system S assigns 0.4 to variable w at Step S209.

Next, system S multiplies the amplitude of TPTRC by (w−0.1), w, and (w+0.1), respectively, generating three amplitude-scaled TPTRCs (Step S210). For example, if variable w is set to 0.4 at Step S209, system S generates TPTRC(0.3), TPTRC(0.4), and TPTRC(0.5) at Step S210.

System S sequentially outputs sounds obtained by superimposing on evaluation sounds each TPTRC(W) generated at Step S210 and the inverse characteristic IP to the sound-emitting device (Step S211).

Individual P listens to the sounds emitted at Step S211, selects one that provides a highest level of satisfaction, and inputs the selection result to system S. System S acquires the selection result input by individual P (Step S212).

System S assigns the multiplier W used to generate the TPTRC(W) corresponding to the selection result acquired at Step S212 (hereinafter multiplier W3) to variable w (Step S213). For example, if the selection result specifies the sound superimposed with TPTRC(0.3), system S assigns 0.3 to variable w.

Next, system S multiplies the amplitude of TPTRC by (w−0.05), w, and (w+0.05), respectively, generating three amplitude-scaled TPTRCs (Step S214). For instance, if variable w is 0.3, system S generates TPTRC(0.25), TPTRC(0.3), and TPTRC(0.35) at Step S214.

System S sequentially outputs sounds obtained by superimposing on evaluation sounds each TPTRC(W) generated at Step S214 and the inverse characteristic IP to the sound-emitting device (Step S215).

Individual P listens to the sounds output at step 215, selects the one that provides the highest level of satisfaction, and inputs the selection result to system S. System S acquires the selection result input by individual P (Step S216).

System S stores the TPTRC(W) corresponding to the selection result acquired at Step S216 as TPTRCadj, the TPTRC(W) that provides individual P with the highest level of satisfaction (Step S217). For example, if the selection result corresponds to the sound superimposed with TPTRC(0.35), system S stores TPTRC(0.35) as TPTRCadj. This stored TPTRCadj is the TRC-I in this example.

The final TRC-I obtained in this example, i.e., TPTRCadj, is a TRC for which a degree of clarification of information affecting sound timbre recognition is adjusted in accordance with preferences of individual P.

At Step S217, instead of storing TPTRCadj, system S may store the multiplier W (e.g., “0.35”) used to generate the TPTRC(W) corresponding to the selection result acquired at Step S216.

As described above, in this example, the sound selection procedure, in which sounds superimposed with amplitude-scaled TPTRC(W) obtained by multiplying TPTRC by a predetermined number of different multipliers W are presented to individual P and individual P selects a preferred sound, is repeated multiple times. Although three choices are presented to individual P per procedure in the above example, any number of two or more choices may be provided. However, presenting three choices is preferable because it reduces a burden on individual P while obtaining highly accurate results.

Moreover, although in the above example it is assumed that the sound selection procedure is repeated four times, any number of one or more repetitions is possible.

In the above example, the difference between adjacent two values of multiplier W used to generate options presented to individual P in a preceding sound selection procedure is assumed to be equal. However, as long as the variation of multiplier W used in a subsequent sound selection procedure is smaller than that in the preceding procedure, the difference between adjacent multipliers W may be changed.

Further, if the multiplier W corresponding to the selected sound in a preceding sound selection procedure differs from that in a subsequent sound selection procedure by a predetermined threshold or more, system S may return the process to the preceding sound selection procedure and repeat the subsequent processing.

Also, by mixing sounds generated using multiplier W values distant from that selected in a preceding sound selection procedure into the options presented to individual P in a subsequent sound selection procedure, it is possible to verify whether the sound selection is being performed correctly. That is, if a sound generated using a multiplier W distant from the previously selected multiplier W is selected in the subsequent procedure, there is a high possibility that the selection is incorrect, and system S may return to the preceding procedure and repeat subsequent processing.

While the above example assumes all multipliers W are less than or equal to 1, the range of multiplier W is not limited thereto, and any multiplier W equal to or greater than zero may be used.

Moreover, after individual P listens to the sound superimposed with TPTRCadj for a predetermined time or longer, the process shown in FIG. 3 may be executed again to update the TPTRCadj for individual P.

In the above example, sound selection is performed based on the subjective preference of individual P; however, the selection may be performed by system S based on vital information of individual P. Examples of vital information include brain waves, heart rate, pulse rate, body temperature, and the like, and any type of vital information correlated with individual P's level of satisfaction while listening to sound may be used.

In such cases, during sound playback at Steps S203, S207, S211, and S215, system S acquires vital information (e.g., brain waves) of individual P measured by a measurement device (e.g., EEG) and, instead of acquiring selection results input by individual P at Steps S204, S208, S212, and S216, evaluates the level of satisfaction of individual P based on the acquired vital information, and selects the sound providing the highest level of satisfaction accordingly.

Selecting sound based on vital information allows objective selection compared to subjective selection by individual P, thereby reducing a burden on individual P and reducing a likelihood of incorrect selection.

### Third Example

Next, a third example of the first embodiment will be described.

In this example, the average of TPTRCs stored at Step S110 in the first example for multiple individuals (hereinafter individuals P1 to Pn, where n is any natural number) is identified as TRC-I.

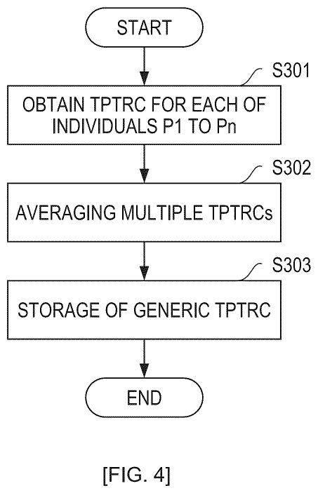

FIG. 4 is a flowchart illustrating a method for generating TRC-I according to this example.

First, system S acquires the TPTRCs for each of individuals P1 to Pn (Step S301).

Next, system S calculates an average of the amplitudes of the acquired TPTRCs as a generic TPTRC (Step S302).

System S stores the calculated generic TPTRC (Step S303). The stored generic TPTRC is TRC-I in this example.

The generic TPTRC is obtained by averaging TPTRCs for multiple individuals, and thus provides clarity of information affecting timbre recognition for a person having an average 3D body shape. Accordingly, an individual who has not specified an HRTF and who listens to sound superimposed with the generic TPTRC is likely to obtain a high level of satisfaction regarding timbre.

In this example, instead of the TPTRC stored at Step S110 in the first example, the TPTRCadj stored at Step S217 in the second example may be used. In that case, the average of TPTRCadj (generic TPTRCadj) is identified as TRC-I.

Also, in this example, TPTRCs (or TPTRCadjs) for multiple individuals P are averaged. Thus, a generic TPTRC (or generic TPTRCadj) related only to one ear, either left or right, may be calculated and used as the generic TPTRC (or generic TPTRCadj) for both ears.

Further, instead of averaging HRTF-Lav or HRTF-Rav obtained at Step S109 in the first example for each individual P1 to Pn, system S may obtain the generic TPTRC by averaging multiple HRTF-Ls or HRTF-Rs before averaging at Step S109 for each individual.

### Fourth Example

Next, a fourth example of the first embodiment will be described.

In this example, for multiple individuals (individuals Pl to Pn, where n is any natural number), using the TPTRCs stored at Step S110 in the first example and information representing the 3D shape of each individual's body corresponding to a TPTRC, system S identifies a correspondence between body 3D shape and TPTRC, and based on this correspondence, identifies a TPTRC suitable for an individual who has not undergone HRTF identification as TRC-I.

In executing this example, first, three-dimensional body shape data representing the 3D shape of an individual's body (hereinafter “three-dimensional body shape data”) is acquired at the time of executing the first example. The three-dimensional body shape data represents at least the 3D shape of the individual's head, and preferably also the 3D shape of the outer ear. The three-dimensional body shape data may be acquired by any method such as direct measurement by scanning or calculation based on images obtained from multiple directions. When HRTF identification is performed by simulation at Step S102 of the first example and the individual's 3D body shape is measured or calculated for that purpose, the data representing that 3D shape is acquired as the three-dimensional body shape data. System S stores the three-dimensional body shape data thus acquired in association with the individual's TPTRC.

When the three-dimensional body shape data and TPTRC are stored in association for each of individuals P1 to Pn, system S performs regression analysis using the three-dimensional body shape data as explanatory variables and the TPTRC as objective variables, and calculates a regression equation.

In a state where the regression equation is calculated as above, system S acquires three-dimensional body shape data of an individual X who has not undergone HRTF identification.

Then, system S inputs the acquired three-dimensional body shape data as explanatory variables into the regression equation to obtain a TPTRC as objective variables. As a result, a TPTRC suitable for individual X is obtained. System S stores the TPTRC thus calculated as the TPTRC for individual X.

When new three-dimensional body shape data and TPTRC for a new individual are obtained, system S may use this data as sample data to recalculate the regression equation.

Instead of the regression equation described above, a trained machine learning model may be used. In that case, system S constructs or updates the trained machine learning model using training data in which three-dimensional body shape data are explanatory variables and TPTRC are objective variables for each of individuals P1 to Pn.

Then, system S inputs the three-dimensional body shape data of individual X as explanatory variables into the trained machine learning model and obtains TPTRC as the objective variable output. As a result, a TPTRC suitable for individual X is obtained. System S stores the TPTRC thus calculated as the TPTRC for individual X.

The TPTRC for individual X specified and stored using the regression equation or trained machine learning model as described above is the TRC-I in this example.

In this example, instead of the TPTRC stored at Step S110 in the first example, the TPTRCadj stored at Step S217 in the second example may be used. In that case, a TPTRCadj suitable for individual X is specified as TRC-I.

### Fifth Example

Next, a fifth example of the first embodiment will be described.

In this example, for each of multiple individuals (individuals P1 to Pn, where n is any natural number), the multiplier W used to generate TPTRCadj stored at Step S217 in the second example and information representing the 3D shape of the individual's body are used to identify a correspondence between the body 3D shape and multiplier W. Based on this correspondence, a TPTRCadj suitable for an individual who does not undergo the sound selection procedure of the second example is specified as TRC-I.

In executing this example, TPTRCadj is specified for each of individuals P1 to Pn according to the methods of the first and second examples. At the time of executing the first example, three-dimensional body shape data of the individual P is acquired. System S stores the acquired three-dimensional body shape data in association with the multiplier W used to generate TPTRCadj for that individual P.

When three-dimensional body shape data and multiplier W are stored in association for individuals P1 to Pn, system S performs regression analysis using the three-dimensional body shape data as explanatory variables and multiplier W as objective variables, and calculates a regression equation.

In a state where the regression equation is calculated, system S acquires three-dimensional body shape data of an individual X who has specified TPTRC according to the first example but has not specified TPTRCadj according to the second example.

Then, system S inputs the acquired three-dimensional body shape data as explanatory variables into the regression equation and obtains multiplier W as the objective variable. As a result, a multiplier W suitable for individual X is obtained. System S generates a TPTRCadj for individual X by multiplying the TPTRC for individual X by the multiplier W thus calculated.

When new three-dimensional body shape data and multiplier W for a new individual are obtained, system S may use these as sample data to recalculate the regression equation.

Instead of the regression equation described above, a trained machine learning model may be used. In that case, system S constructs or updates the trained machine learning model using training data in which three-dimensional body shape data are explanatory variables and multiplier W is the objective variable for each of individuals P1 to Pn.

Then, system S inputs the three-dimensional body shape data of individual X as explanatory variables into the trained machine learning model and obtains multiplier W as the objective variable output. As a result, a multiplier W suitable for individual X is calculated. System S stores the calculated TPTRCadj for individual X.

The TPTRCadj generated and stored using the regression equation or trained machine learning model as described above is the TRC-I in this example.

### Second Embodiment

Next, an exemplary embodiment of a device that generates sound data or outputs sound using the TRC-I specified in the above first embodiment will be described as a second embodiment. According to the device described below, sounds that provide a high level of satisfaction with regard to timbre for listeners can be obtained.

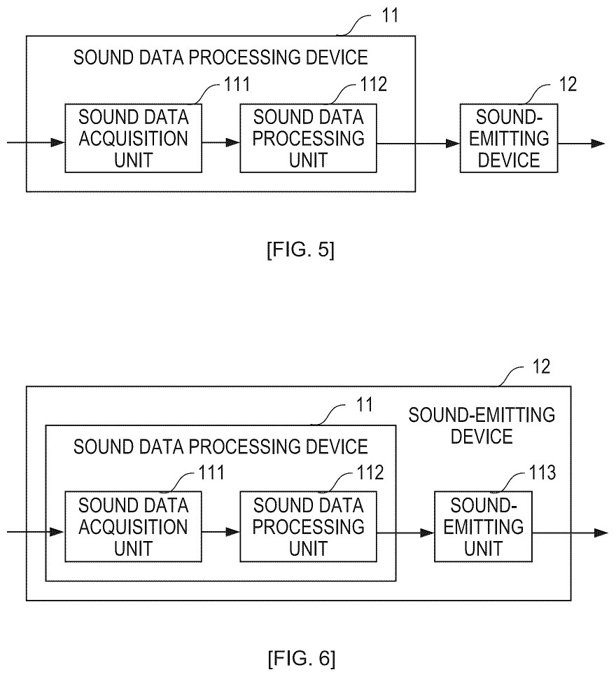

FIG. 5 illustrates a configuration example of a sound data processing system 1 according to this embodiment. The sound data processing system 1 shown in FIG. 5 includes a sound data processing device 11 and a sound-emitting device 12. The sound data processing device 11 includes a sound data acquisition unit 111 that acquires sound data representing sound from an external device, and a sound data processing unit 112 that performs processing such as superimposing TRC-I on the sound data acquired by the sound data acquisition unit 111. The sound data processing unit 112 outputs the processed sound data to the sound-emitting device 12.

The sound data processing device 11 may be a dedicated module or unit, or may be a general-purpose computer (e.g., server device, personal computer, smartphone, etc.). When realized by a computer, the sound data processing device 11 executes processing such as superimposing TRC-I on sound data in accordance with a program according to this embodiment non-transitorily stored in a memory by a processor.

The sound-emitting device 12 is a device that emits sound represented by sound data input from the sound data processing device 11, and may be of any form such as earphones, headphones, or speakers.

The sound data input to the sound data processing device 11 and the sound data output from the sound data processing device 11 to the sound-emitting device 12 may be output either as digital or analog signals. The sound data processing device 11 and the sound-emitting device 12 perform digital-to-analog and analog-to-digital conversions as necessary.

FIG. 6 illustrates an example configuration of the sound-emitting device 12 implemented instead of the sound data processing system 1 according to this embodiment. The sound-emitting device 12 shown in FIG. 6 is a sound-emitting device that incorporates the sound data processing device 11 included in the sound data processing system 1 of FIG. 5. That is, the sound-emitting device 12 shown in FIG. 6 includes, within its housing, a sound data acquisition unit 111 that acquires sound data representing sound from an external device, a sound data processing unit 112 that performs processing such as superimposing TRC-I on the acquired sound data, and a sound-emitting unit 113 that emits sound represented by the sound data processed by the sound data processing unit 112.

### First Example

In this example, the sound data processing unit 112 simply generates sound data obtained by superimposing TRC-I on the input sound data and outputs the generated sound data.

According to this example, sounds following the TRC obtained by adding the TRC inherent to the sound-emitting device 12 of FIG. 5 or the sound-emitting unit 113 of FIG. 6 and the TRC-I are emitted to the listener.

The frequency band subject to superimposition of TRC-I by the sound data processing unit 112 may be changed depending on the use. That is, superimposition of TRC-I may be performed over the entire audible frequency range, or, for example, only over a frequency band from 1 kHz to 10 kHz. At boundaries between frequency bands where TRC-I is superimposed and frequency bands where TRC-1 is not superimposed, multiplication by a window function or the like is performed for amplitude smoothing.

### Second Example

In this example, the sound data processing unit 112 generates and outputs sound data obtained by superimposing the following two amplitude frequency characteristics on the input sound data:
(1) Inverse characteristic of the TRC inherent to the sound-emitting device 12 of FIG. 5 or the sound-emitting unit 113 of FIG. 6
(2) TRC-I

According to this example, the inherent TRC of the sound-emitting device 12 of FIG. 5 or the sound-emitting unit 113 of FIG. 6 is canceled, and sound following only the TRC-I is emitted to the listener.

Also in this example, as in the first example, the frequency band subject to superimposition of the above amplitude frequency characteristics by the sound data processing unit 112 may be changed depending on use.

### Third Example

In this example, the sound data processing unit 112 generates and outputs sound data obtained by superimposing the following three amplitude frequency characteristics on the input sound data:
(1) Inverse characteristic of the TRC inherent to the sound-emitting device 12 of FIG. 5 or the sound-emitting unit 113 of FIG. 6
(2) TRC-I
(3) A specific TRC selected by, for example, a product designer

According to this example, the inherent TRC of the sound-emitting device 12 of FIG. 5 or the sound-emitting unit 113 of FIG. 6 is canceled, and sound following the TRC obtained by adding the specific TRC selected by, for example, a product designer and the TRC-I is emitted to the listener.

Also in this example, as in the first and second examples, the frequency band subject to superimposition of the above amplitude frequency characteristics by the sound data processing unit 112 may be changed depending on use.

### Fourth Example

In this example, either the individual TPTRC specified by the method of the first example of the first embodiment or the generic TPTRC specified by the method of the third example of the first embodiment is used. In this description, the individual TPTRC or generic TPTRC is simply referred to as TPTRC.

In this example, the sound data processing unit 112 acquires a multiplier W that changes according to a listener operation and outputs sound data obtained by superimposing TPTRC(W), which is the TPTRC multiplied by the acquired multiplier W, on the input sound data.

The sound data processing device 11 (FIG. 5) or the sound-emitting device 12 (FIG. 6) includes, for example, an operator such as a knob or fader (either physical or virtual) that accepts listener operations, and acquires the multiplier W according to the operation performed by the listener on the operator.

Also, the sound data processing device 11 (FIG. 5) or the sound-emitting device 12 (FIG. 6) may acquire the multiplier W transmitted from an external device such as a terminal device used by the listener, or the multiplier W input from the external device according to the listener's operation.

According to the sound data processing system 1 (FIG. 5) or the sound-emitting device 12 (FIG. 6) of this example, the listener can change the multiplier W according to preference while listening to the emitted sound.

Also in this example, as in the first to third examples, the frequency band subject to superimposition of TPTRC(W) by the sound data processing unit 112 may be changed depending on use.

### Fifth Example

In this example, when a listener listens to music or the like, selection of multiplier W is performed based on the direct-to-reverberant ratio of the sound produced by the music or the like, that is, the ratio of direct sound energy to reverberant sound energy, and amplitude-scaled TPTRC(W) using the selected multiplier W is superimposed on the music or the like and emitted.

First, multiple sounds having different direct-to-reverberant ratios are prepared as evaluation sounds. For each of these evaluation sounds, the TPTRCadj of individual P is specified according to the method of the second example of the first embodiment. Hereinafter, the TPTRCadj specified using evaluation sound with direct-to-reverberant ratio R is denoted as TPTRCadj(R).

The sound data processing unit 112 temporarily stores sound data input when individual P listens to music or the like, identifies the direct-to-reverberant ratio r of the sound represented by all or part of the sound data by a known method, temporarily superimposes the TPTRCadj corresponding to the identified direct-to-reverberant ratio r, i.e., TPTRCadj(r), on the sound data, and outputs the sound data.

If the stored TPTRCadj(R) is discrete, the sound data processing unit 112 may use interpolation to specify TPTRCadj(r). Alternatively, instead of storing TPTRCadj(R), the sound data processing unit 112 may store multipliers W corresponding to the direct-to-reverberant ratio R and calculate TPTRCadj(r) by multiplying TPTRC by the multiplier W corresponding to the direct-to-reverberant ratio r of the emitted sound.

In this example, a generic TPTRCadj may be used instead of the individual TPTRCadj of individual P.

Also in this example, as in the first to fourth examples, the frequency band subject to superimposition of TPTRC(W) by the sound data processing unit 112 may be changed depending on use.

1. A method for generating information to enhance timbre using characteristics of an individual, comprising:
identifying, for each of a plurality of directions determined by a combination of a plurality of horizontal angles, which are defined by a predetermined angular resolution within a predetermined range of horizontal angles, and a plurality of elevation angles, which are defined by a predetermined angular resolution within a predetermined range of elevation angles, from which sound is emitted toward a head of the individual, a transfer function or information equivalent to the transfer function representing sound reaching an ear of the individual; and
calculating an averaged transfer function or information equivalent to the averaged transfer function by averaging the transfer functions or the information equivalent to the transfer function identified for each of the multiple directions.

2. The method according to claim 1, wherein:
the step of calculating the averaged transfer function or the information equivalent to the averaged transfer function comprises calculating a weighted average using different weights according to angles of the multiple directions.

3. The method according to claim 1, wherein:
the step of calculating the averaged transfer function or the information equivalent to the averaged transfer function comprises averaging only within a predetermined frequency band.

4. The method according to claim 1, wherein:
the step of identifying the transfer function or the information equivalent to the transfer function comprises identifying the transfer function or the information equivalent to the transfer function for each of a plurality of individuals, and
the step of calculating the averaged transfer function or the information equivalent to the averaged transfer function comprises averaging the transfer functions or the information equivalent to the transfer function identified for each of the plurality of individuals.

5. The method according to claim 1, further comprising:
calculating an amplitude-scaled transfer function or information equivalent to the amplitude-scaled transfer function by multiplying amplitudes of an amplitude frequency characteristic by a multiplier equal to or greater than zero, the amplitude frequency characteristic being represented by the averaged transfer function or the information equivalent to the averaged transfer function.

6. The method according to claim 5, wherein:
the step of calculating the amplitude-scaled transfer function or the information equivalent to the amplitude-scaled transfer function comprises multiplying the amplitudes by the multiplier only within a predetermined frequency band.

7. The method according to claim 5, wherein:
the step of calculating the amplitude-scaled transfer function or the information equivalent to the amplitude-scaled transfer function comprises, for each of a plurality of multipliers equal to or greater than zero, calculating the amplitude-scaled transfer function or the information equivalent to the amplitude-scaled transfer function using the multiplier,
the method further comprises:
for each of the plurality of the amplitude-scaled transfer functions or the information equivalent to the amplitude-scaled transfer functions calculated in the step of calculating the amplitude-scaled transfer function or the information equivalent to the amplitude-scaled transfer function, generating sound on which the amplitude-scaled transfer function or the information equivalent to the amplitude-scaled transfer function is superimposed, and
sequentially emitting the generated sounds to prompt a listener who listens to the sounds to select one of the sounds.

8. The method according to claim 7, wherein:
the step of generating sound on which the amplitude-scaled transfer function or the information equivalent to the amplitude-scaled transfer function is superimposed comprises generating the sound on which an inverse characteristic of a target response curve of a sound-emitting device used for emitting the sound is further superimposed.

9. The method according to claim 7, further comprising:
performing multiple times the step of sequentially emitting the generated sounds to prompt the listener who listens to the sounds to select one of the sounds,
wherein:
in each of the multiple performances of the step of sequentially emitting the generated sounds, a predetermined number of sounds is emitted, and
a variation of the multipliers used for calculating the amplitude-scaled transfer functions or the information equivalent to the amplitude-scaled transfer functions superimposed on the sounds emitted in each of the multiple performances of the step of sequentially emitting the generated sounds is gradually reduced.

10. The method according to claim 7, further comprising:
performing multiple times the step of sequentially emitting the generated sounds to prompt the listener who listens to the sounds to select one of the sounds, and
after each preceding performance of the step of sequentially emitting the generated sounds, emitting a selected sound, for a predetermined period of time or longer, before a subsequent performance of the step of sequentially emitting the generated sounds, the selected sound being a sound on which the amplitude-scaled transfer function or the information equivalent to the amplitude-scaled transfer function, which is superimposed on a sound selected by the listener in a preceding performance of the step of sequentially emitting the generated sounds, is superimposed.

11. The method according to claim 5, wherein:
the step of calculating the amplitude-scaled transfer function or the information equivalent to the amplitude-scaled transfer function comprises, for each of a plurality of multipliers equal to or greater than zero, calculating the amplitude-scaled transfer function or the information equivalent to the amplitude-scaled transfer function using the multiplier,
the method further comprises:
for each of the plurality of the amplitude-scaled transfer functions or the information equivalent to the amplitude-scaled transfer functions calculated in the step of calculating the amplitude-scaled transfer function or the information equivalent to the amplitude-scaled transfer function, generating sound on which the amplitude-scaled transfer function or the information equivalent to the amplitude-scaled transfer function is superimposed,
sequentially emitting the generated sounds,
acquiring vital information of a listener who listens to the emitted sounds; and
selecting one of the emitted sounds based on the vital information.

12. The method according to claim 11, wherein
the step of generating sound on which the amplitude-scaled transfer function or the information equivalent to the amplitude-scaled transfer function is superimposed comprises generating the sound on which an inverse characteristic of a target response curve of a sound-emitting device used for emitting the sound is further superimposed.

13. The method according to claim 5, further comprising:
identifying a multiplier corresponding to a three-dimensional shape of a body of a specific individual by using a regression equation or a trained machine learning model in which information representing the three-dimensional shape of a body of the individual is used as an explanatory variable and a multiplier is used as an objective variable,
wherein:
the step of calculating the amplitude-scaled transfer function or the information equivalent to the amplitude-scaled transfer function is performed using the multiplier identified in the step of identifying the multiplier.

14. The method according to claim 7, further comprising:
performing the step of sequentially emitting the generated sounds to prompt the listener who listens to the sounds to select one of the sounds for each of a plurality of individuals,
generating or updating for each of the plurality of individuals, a regression equation or trained machine learning model using data indicating information representing a three-dimensional shape of a body of the individual as an explanatory variable and a multiplier as an objective variable, the multiplier being used in the step of calculating the amplitude-scaled transfer function or the information equivalent to the amplitude-scaled transfer function superimposed on the sound selected by the individual in the step of sequentially emitting the generated sounds, and
identifying a multiplier corresponding to a three-dimensional shape of a body of a specific individual by using the regression equation or the trained machine learning model generated or updated in the step of generating or updating the regression equation or the trained machine learning model,
wherein:
the step of calculating the amplitude-scaled transfer function or the information equivalent to the amplitude-scaled transfer function is performed using the multiplier identified in the step of identifying the multiplier.

15. The method according to claim 11, further comprising:
performing the step of selecting one of the emitted sounds for each of a plurality of individuals,
generating or updating for each of the plurality of individuals a regression equation or trained machine learning model using data indicating information representing a three-dimensional shape of a body of the individual as an explanatory variable and a multiplier as an objective variable, the multiplier being used in the step of calculating the amplitude-scaled transfer function or the information equivalent to the amplitude-scaled transfer function superimposed on the sound selected in the step of selecting one of the emitted sounds for the individual, and
identifying a multiplier corresponding to a three-dimensional shape of a body of a specific individual by using the regression equation or the trained machine learning model generated or updated in the step of generating or updating the regression equation or the trained machine learning model,
wherein:
the step of calculating the amplitude-scaled transfer function or the information equivalent to the amplitude-scaled transfer function is performed using the multiplier identified in the step of identifying the multiplier.

16. The method according to claim 5, further comprising:
identifying a direct-to-reverberant ratio, which is a ratio of direct sound energy to reverberant sound energy contained in an emitted sound,
wherein:
the step of calculating the amplitude-scaled transfer function or the information equivalent to the amplitude-scaled transfer function is performed using a multiplier corresponding to the identified direct-to-reverberant ratio.

17. The method according to claim 7, further comprising:
performing the step of sequentially emitting the generated sounds to prompt the listener who listens to the sounds to select one of the sounds for each of a plurality of individuals, and
calculating an averaged transfer function or information equivalent to the averaged transfer function by averaging the transfer functions or the information equivalent to the transfer functions superimposed on the sounds selected by the plurality of individuals.

18. The method according to claim 11, further comprising:
performing the step of selecting one of the emitted sounds for each of the plurality of individuals, and
calculating an averaged transfer function or information equivalent to the averaged transfer function by averaging the transfer functions or the information equivalent to the transfer functions superimposed on the sounds selected in the step of selecting one of the emitted sounds for the plurality of individuals.

19. A system for generating information to enhance timbre using characteristics of an individual, comprising:
a processing unit configured to identify, for each of multiple a plurality of directions determined by a combination of a plurality of horizontal angles, which are defined by a predetermined angular resolution within a predetermined range of horizontal angles, and a plurality of elevation angles, which are defined by a predetermined angular resolution within a predetermined range of elevation angles, from which sound is emitted toward a head of an individual, a transfer function or information equivalent to the transfer function representing sound reaching an ear of the individual ; and
the processing unit further configured to calculate an averaged transfer function or information equivalent to the averaged transfer function by averaging the transfer functions or the information equivalent to the transfer function identified for each of the multiple directions.

20-50. (canceled)
